(19) United States
(12) Patent Application Publication
(10) Pub. No.: US 2015/0273701 A1
(43) Pub. Date: Oct. 1, 2015

(54) RIGID MECHANICAL ARM AND PLATE

(71) Applicant: HON HAI PRECISION INDUSTRY CO., LTD., New Taipei (TW)

(72) Inventors: YU-CHEN TING, New Taipei (TW); CHIH-HANG CHAO, New Taipei (TW)

(21) Appl. No.: 14/587,498

(22) Filed: Dec. 31, 2014

(30) Foreign Application Priority Data
Mar. 28, 2014 (TW) 103111624

(51) Int. Cl. B25J 18/00

(52) U.S. Cl. CPC B25J 18/00

(57) ABSTRACT

A rigid mechanical arm includes two parallel first plates and two second plates. At least one of the two second plates defines openings to reduce the weight of the second plate. The rigid mechanical arm includes a plurality of first posts and second posts. The plurality of first posts is perpendicular to plurality of second posts. Each second post connects to the two first plates. Each first post connects to the two second plates to enhance the rigidity of the rigid mechanical arm along a direction substantially perpendicular to the two second plates.

### CROSS-REFERENCE TO RELATED APPLICATIONS

This application claims priority to Taiwanese Patent Application No. 103111624 filed on Mar. 28, 2014, the contents of which are incorporated by reference herein.

### FIELD

The subject matter herein generally relates to structural science.

### BACKGROUND

Robots are widely used in industrial production because of automation and high efficiency. A robotic arm is a type of rigid mechanical arm, usually programmable, with similar functions to a human arm, and can be designed to perform any task such as welding, gripping, and spinning.

### BRIEF DESCRIPTION OF THE DRAWINGS

Implementations of the present technology will now be described, by way of example only, with reference to the attached figures.

FIG. 1 is an isometric view of one embodiment of a rigid mechanical arm.

FIG. 2 is an isometric, cross-sectional view of the rigid mechanical arm of FIG. 1.

FIG. 3 is similar to FIG. 1, but in a state of use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a rigid mechanical arm.

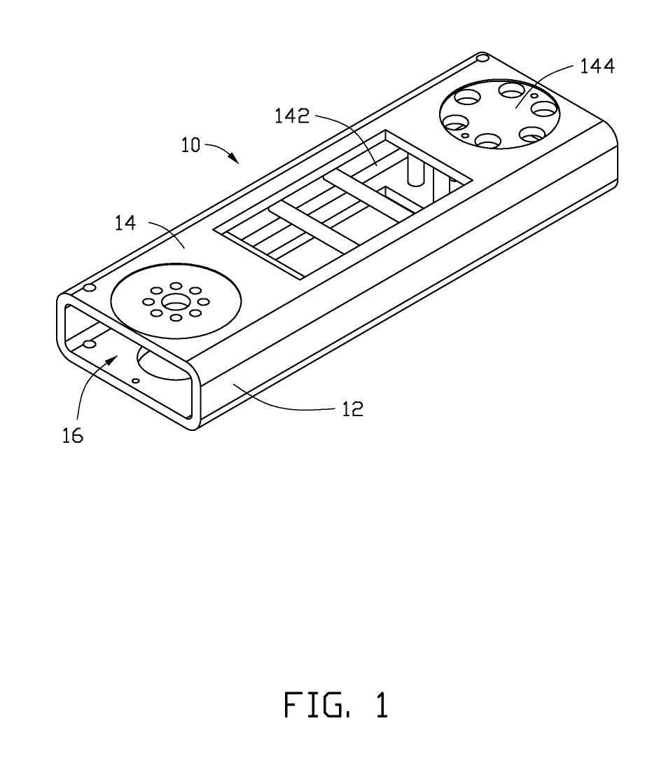

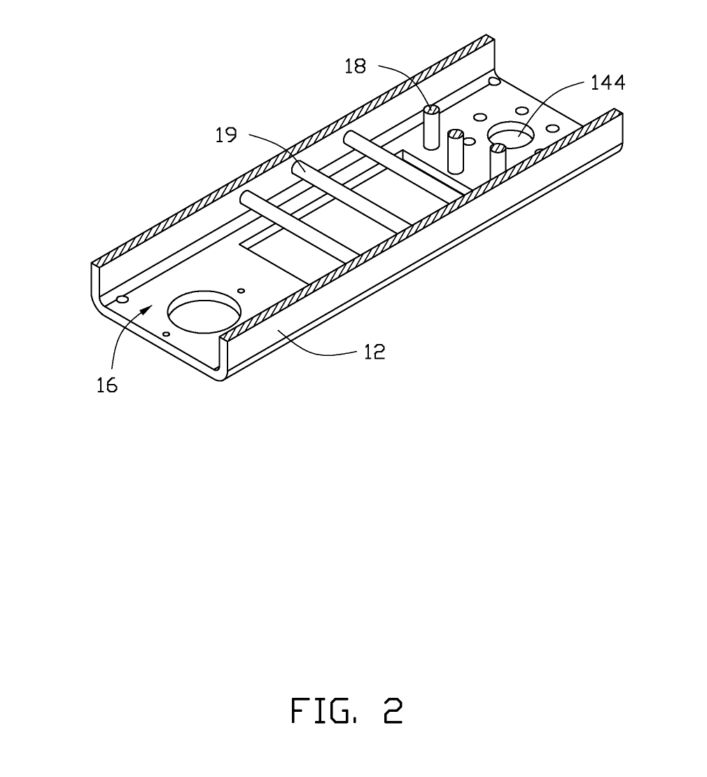

FIGS. 1 and 2 illustrate one embodiment of a rigid mechanical arm 10. The rigid mechanical arm 10 includes two first plates 12, two second plates 14, a plurality of first posts 18, and a plurality of second posts 19. The two first plates 12 are substantially parallel to each other. The two second plates 14 are substantially parallel to each other. Each second plate 14 is substantially perpendicular to the each first plate 12. Each first plate 12 connects the two second plates 14. The two first plates 12 and the two second plates 14 cooperatively define a space 16. In at least one embodiment, the rigid mechanical arm 10 can be hollow. A cross section of the rigid mechanical arm 10 can be rectangular.

The first posts of the plurality of first posts 18 are substantially parallel to each other. The second posts of the plurality of second posts 19 are substantially parallel to each other. Each first post 18 is substantially perpendicular to each second post 19. Each first post 18 connects the two second plates 14 and is substantially perpendicular to the two second plates 14. Each second post 19 connects the two first plates 12 and is substantially perpendicular to the two first plates 12. A plurality of projections of the second posts 19 on the two first plates 12 is in a straight line. Distances from the straight line to the two second plates 14 are substantially equal. Each second plate 14 defines an opening 142 and includes two connecting portions 144. The two connecting portions 144 are located on opposite sides of the each second plate 14. Each opening 142 is located between the two connecting portions 144. Each second post 19 is located between the two openings 142. The plurality of first posts 18 is located on one side of the each opening 142. The plurality of first posts 18 and the plurality of second posts 19 are located in the space 16. A weight of the material removed to create the two openings 142 in the two second plates 14 can be greater than a weight of the plurality of first posts 18 and the plurality of second posts 19. The shape of the two openings 142 can be triangular, rectangular, or circular. In at least one embodiment, the shape of the two openings 142 is substantially rectangular.

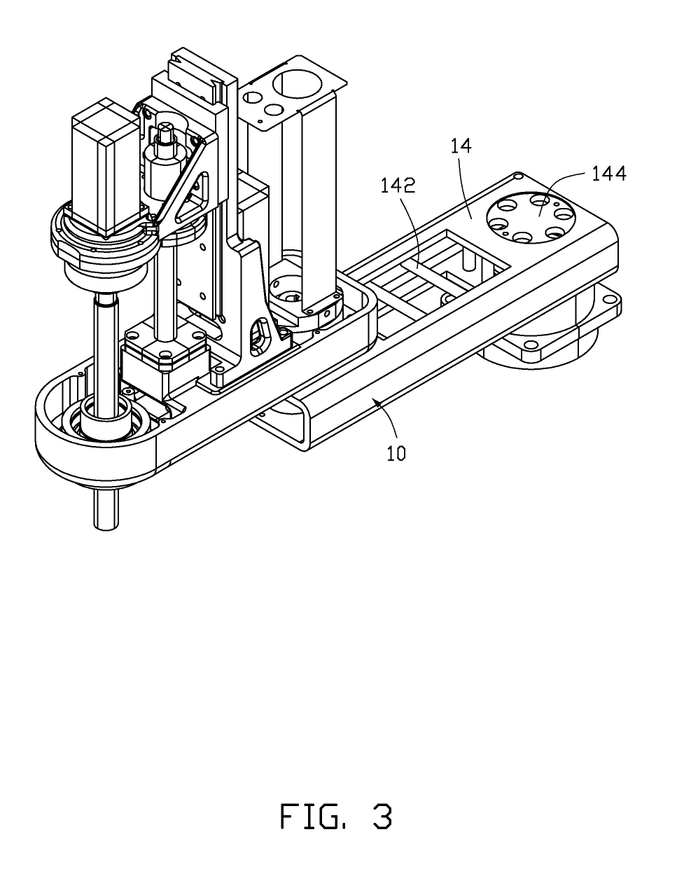

FIG. 3 illustrates a view of the rigid mechanical arm 10 in a state of use. A connecting portion 144 is connected to a fixing portion and a connecting portion 144 is connected to an operating portion. The end of the rigid mechanical arm 10 connected with the operating portion is constrained to move along a direction which is perpendicular to the second plate 14. The plurality of first posts 18 and the plurality of second posts 19 enhance the rigidity of the rigid mechanical arm 10 along a direction substantially perpendicular to the second plate 14. The moving direction is substantially perpendicular to the two second plates 14.

FIGS. 1 and 2 also illustrate one embodiment of a plate.

The embodiments shown and described above are only examples. Many details are often found in the art such as the other features of a rigid mechanical arm. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A rigid mechanical arm comprising:
two first plates substantially parallel to each other;
two second plates substantially parallel to each other, and at least one second plate defining an opening;
a plurality of first posts; and
a plurality of second posts, each second post substantially perpendicular to each first post;
wherein each first plate is substantially perpendicular to each second plate, each first post connects the two second plates, each second post connects the two first plates, and the plurality of first posts and the plurality of second posts enhance the rigidity of the rigid mechanical arm along a direction substantially perpendicular to the second plate.

2. The rigid mechanical arm of claim 1, wherein the two first plates and the two second plates cooperatively define a space, and the plurality of first posts and the plurality of second posts are located in the space.

3. The rigid mechanical arm of claim 2, wherein a cross section of the rigid mechanical arm is substantially rectangular.

4. The rigid mechanical arm of claim 1, wherein each second plate defines an opening, and each second post is located between the two openings.

5. The rigid mechanical arm of claim 1, wherein each second plate includes two connecting portions, the opening is defined between the two connecting portions.

6. The rigid mechanical arm of claim 5, wherein the two connecting portions are located on the two opposite ends of the each second plate.

7. The rigid mechanical arm of claim 1, wherein a plurality of projections of the second posts on the one of the two first plates is located on a straight line, and two distances from the straight line to the two second plates are substantially equal.

8. The rigid mechanical arm of claim 1, wherein the plurality of first posts is located on one side of the opening.

9. The rigid mechanical arm of claim 1, wherein each first post is substantially perpendicular to the two second plates.

10. A plate comprising:
two first plates substantially parallel to each other;
two second plates substantially parallel to each other, and at least one second plate defining an opening;
a plurality of first posts; and
a plurality of second posts, each second post substantially perpendicular to each first post;
wherein each first plate is substantially perpendicular to each second plate, each first post connects the two second plates, each second post connects the two first plates, and the plurality of first posts and the plurality of second posts enhance the rigidity of the plate along a direction perpendicular to the second plate.

11. The plate of claim 10, wherein the two first plates and the two second plates cooperatively define a space, and the plurality of first posts and the plurality of second posts are located in the space.

12. The plate of claim 11, wherein a cross section of the plate is substantially rectangular.

13. The plate of claim 10, wherein each second plate defines an opening, and each second post is located between the two openings.

14. The plate of claim 10, wherein each second plate includes two connecting portions, the opening is defined between the two connecting portions.

15. The plate of claim 14, wherein the two connecting portions are located on the two opposite ends of the each second plate.

16. The plate of claim 10, wherein a plurality of projections of the second posts on the one of the two first plates is located on a straight line, and two distances from the straight line to the two second plates are substantially equal.

17. The plate of claim 10, wherein the plurality of first posts is located on one side of the opening.

18. The plate of claim 10, wherein each first post is substantially perpendicular to the two second plates.
